(19) United States
(12) Patent Application Publication
(10) Pub. No.: US 2012/0148478 A1
(43) Pub. Date: Jun. 14, 2012

(54) PROCESS FOR THE PREPARATION OF CHLORINE BY GAS PHASE OXIDATION ON NANOSTRUCTURED SUPPORTED RUTHENIUM CATALYSTS

(75) Inventors: Timm Schmidt, Neuss (DE); Christoph Gürtler, Koln (DE); Jürgen Kintrup, Leverkusen (DE); Thomas Ernst Müller, Munchen (DE); Tim Loddenkemper, Dormagen (DE); Frank Gerhartz, Leverkusen (DE); Walther Müller, Pulheim (DE)

(73) Assignee: Bayer MaterialScience AG, Leverkusen (DE)

(21) Appl. No.: 13/384,792

(22) PCT Filed: Jul. 14, 2010
(86) PCT No.: PCT/EP2010/004287

§ 371 Date: Jan. 19, 2012

(30) Foreign Application Priority Data
Jul. 25, 2009 (DE) 10 2009 034 773.9

(51) Int. Cl. C01B 7/04; B01J 35/10; B01J 21/02; B01J 21/06; B01J 23/62; B01J 23/14; B01J 27/13; B01J 23/89; B01J 23/755; B01J 23/18; B01J 23/644; B01J 37/08; B01J 23/46; B82Y 30/00; B82Y 40/00

(52) U.S. Cl. 423/502; 502/325; 502/100; 502/261; 502/232; 502/332; 502/355; 502/350; 502/349; 502/352; 502/230; 502/300; 502/326; 502/337; 502/353; 977/773; 977/896; 977/902

(57) ABSTRACT

The present invention relates to a process for the preparation of chlorine by gas phase oxidation using a supported catalyst based on ruthenium, characterised in that the catalyst support has a plurality of pores having a pore diameter>50 nm and carries nanoparticles containing ruthenium and/or ruthenium compounds as catalytically active components.

The present invention relates to a process for the preparation of chlorine by gas phase oxidation using a supported catalyst based on ruthenium, characterised in that the catalyst support has a plurality of pores having a pore diameter>50 nm and carries nanoparticles containing ruthenium and/or ruthenium compounds as catalytically active components.

The process, developed by Deacon in 1868, of catalytic hydrogen chloride oxidation with oxygen in an exothermic equilibrium reaction was the beginning of industrial chlorine chemistry:

4HCl+O_{2→2}Cl₂+2H₂O.

However, the Deacon process was pushed into the background to a great extent by chloralkali electrolysis. Virtually all chlorine was produced by electrolysis of aqueous sodium chloride solutions [Ullmann Encyclopedia of Industrial Chemistry, 7th Edition, 2006]. The attractiveness of the Deacon process has recently increased again, however, because the worldwide chlorine requirement is growing faster than the demand for sodium hydroxide solution. The process for the preparation of chlorine by oxidation of hydrogen chloride, which is not connected with the preparation of sodium hydroxide solution, fits in well with this development. Moreover, large amounts of hydrogen chloride are formed as a by-product in, for example, phosgenation reactions, for example in the preparation of isocyanates.

The oxidation of hydrogen chloride to chlorine is an equilibrium reaction. The position of the equilibrium shifts in favour of the desired end product as the temperature increases. It is therefore advantageous to use catalysts having as high an activity as possible, which allow the reaction to proceed at a lower temperature.

The first catalysts for hydrogen chloride oxidation contained copper chloride or oxide as the active component and were described by Deacon as early as 1868. However, they exhibited only slight activity at a lower temperature (<400° C.).

Although the activity could be increased by raising the reaction temperature, this had the disadvantage that the volatility of the active components at higher temperatures led to a rapid fall in the catalytic activity and to the discharge of the active component from the reactor.

EP 0184413 describes the oxidation of hydrogen chloride using catalysts based on chromium oxides. However, the process carried out therein requires large catalyst loads owing to an inadequate catalytic activity and high reaction temperatures.

The first catalysts for hydrogen chloride oxidation having ruthenium as the catalytically active component were described as early as 1965 in DE 1567788; in this case starting from RuCl₃ e.g. supported on silicon dioxide or aluminium oxide. However, the activity of these RuCl₃/SiO₂ catalysts was very low. Further Ru-based catalysts containing ruthenium oxide or ruthenium mixed oxide as the active component and various oxides as the support material, such as, for example, titanium dioxide, zirconium dioxide, etc., have been claimed in DE-A 19748299. The content of ruthenium oxide in those catalysts is from 0.1 wt. % to 20 wt. % and the mean particle diameter of ruthenium oxide is from 1.0 nm to 10.0 nm. Further Ru catalysts supported on titanium dioxide or zirconium dioxide are known from DE-A 19734412. A number of Ru starting compounds, such as, for example, ruthenium-carbonyl complexes, ruthenium salts of inorganic acids, ruthenium-nitrosyl complexes, ruthenium-amine complexes, ruthenium complexes of organic amines, or ruthenium-acetylacetonate complexes, have been mentioned for the preparation of the ruthenium chloride and ruthenium oxide catalysts mentioned therein, which contain at least one compound titanium dioxide and zirconium dioxide. In a preferred embodiment, TiO₂ in rutile form was used as the support.

DE102007020154A1 and DE102006024543A1 describe a process for catalytic hydrogen chloride oxidation, in which the catalyst contains tin dioxide (as support), preferably tin dioxide in the cassiterite structure, and at least one halogen-containing ruthenium compound (DE102007020154A1) or at least one oxygen-containing ruthenium compound (DE102006024543A1).

The ruthenium-free catalysts developed hitherto for the Deacon process are either too inactive or too unstable. Although the supported ruthenium catalysts described hitherto are suitable in principle for use in the Deacon process, the supports rutile-titanium dioxide and cassiterite-tin dioxide that are claimed as preferred have only small surface areas, owing to their crystalline structure, which is disadvantageous for their use as supports in HCl oxidation.

Accordingly, the object of the present invention was to provide a catalytic system for the oxidation of hydrogen chloride which offers a higher specific (based on the ruthenium content) activity than the catalysts known from the prior art.

Surprisingly, it has been found that the specific (i.e. ruthenium-based) activity and the (high-temperature) stability can be increased significantly by the purposive preparation of nanostructured catalysts.

The present invention relates to a catalyst material for the thermocatalytic preparation of chlorine from hydrogen chloride and oxygen-containing gas, on the basis of a ruthenium-based supported catalyst, characterised in that the catalyst support has a plurality of pores having a pore diameter>50 nm and carries nanoparticles containing ruthenium and/or ruthenium compounds as catalytically active components. The thermocatalytic preparation of chlorine from hydrogen chloride and oxygen-containing gas is generally referred to hereinbelow as the Deacon process for short.

Preferably at least 50%, particularly preferably at least 80%, of the pore volume of the catalyst material according to the invention is present in pores whose diameter is attributed to the macroporous range, i.e. >50 nm. This macroporosity allows the catalyst support to be loaded uniformly with nanoparticles, prevents the pores from becoming blocked by agglomerations of nanoparticles, and leads to reduced pore diffusion limitation during the Deacon reaction.

In order to determine the pore volume and the pore diameter, mercury porosimetry is used within the scope of the invention. The measurement is based on a mercury contact angle of 130° and a surface tension of 480 dyn/cm².

The catalyst material preferably contains as support material one or more compounds from the group: aluminium compounds, silicon compounds, titanium compounds, zirconium compounds or tin compounds, particularly preferably aluminium compounds and/or silicon compounds, and most particularly preferably oxides, oxide mixtures or mixed oxides of one or more metals of the group: aluminium, silicon, titanium, zirconium or tin. Mixed oxides of aluminium and silicon are particularly preferred. In one possible application form, binders, for example μ-Al₂O₃, are added, the primary function of which is not that of a support for the active component.

The ruthenium-containing nanoparticles present on the catalyst material preferably contain as the catalytically active component one or more compounds from the group: ruthenium oxides, ruthenium mixed oxides, ruthenium oxide mixtures, ruthenium oxyhalides, ruthenium halides or metallic ruthenium. Ruthenium chloride, ruthenium oxychloride or mixtures of ruthenium oxide and ruthenium chloride are particularly preferred.

Preferably at least 50% of the ruthenium-containing nanoparticles present on the catalyst have a diameter of not more than 50 nm, particularly preferably at least 50% have a diameter of from 5 nm to 50 nm, most particularly preferably at least 80% have a diameter of from 5 nm to 50 nm. The mean diameter of the ruthenium-containing nanoparticles present on the catalyst is most particularly preferably from 10 to 30 nm. Surprisingly, it is not advantageous to seek maximum dispersion of the ruthenium (i.e. ruthenium primary particles that are as small as possible, e.g. below 5 nm).

Preferably, the ruthenium content of the catalysts is up to 20 wt. %, preferably from 0.1 to 20 wt. %, particularly preferably from 0.5 to 5 wt. %, based on the total weight of the catalyst. Too high a load may lead to the agglomeration of nanoparticles, which is disadvantageous.

Additional nanoparticles having the function of a further active component or of promoters are preferably present on the catalyst material, particularly preferably one or more further metals, metal compounds and mixed compounds of the elements Ag, Au, Bi, Ce, Co, Cr, Cu, Ni, Sb, Sn, Ti, W, Y, Zn, Zr and of the platinum metals, most particularly preferably of the elements Bi, Sb, Sn and Ti. These nanoparticles additionally present on the catalyst preferably contain oxides, mixed oxides, oxide mixtures, oxyhalides, halides, the reduced metals or alloys thereof.

The content of additional nanoparticles present on the catalyst material is preferably up to 20 wt. %, particularly preferably up to 10 wt. %, based on the total weight of the catalyst. Too high a load may lead to the agglomeration of nanoparticles, which is disadvantageous.

Preferably at least 50% of the additional nanoparticles present on the catalyst have a diameter of not more than 50 nm, particularly preferably at least 50% have a diameter of from 3 nm to 50 nm, most particularly preferably at least 80% have a diameter of from 3 nm to 50 nm. The mean diameter of the additional nanoparticles present on the catalyst is most particularly preferably from 5 to 30 nm.

In a possible preferred embodiment, the nanoparticles present on the catalyst contain as promoter at least ruthenium and at least one further metal, preferably Ag, Au, Bi, Ce, Co, Cr, Cu, Ni, Sb, Sn, Ti, W, Y, Zn, Zr and platinum metals, most particularly preferably Bi, Sb, Sn and Ti, that is to say they can be referred to as bimetallic or multimetallic. The nanoparticles so characterised contain oxides, mixed oxides, oxide mixtures, oxyhalides, halides, metals and alloys.

Preferably at least 50% of the bimetallic or multimetallic nanoparticles present on the catalyst have a diameter of not more than 50 nm, particularly preferably at least 50% have a diameter of from 5 nm to 50 nm, most particularly preferably at least 80% have a diameter of from 5 nm to 50 nm. The mean diameter of the bimetallic or multimetallic nanoparticles present on the catalyst is most particularly preferably from 10 to 30 nm.

The content of bimetallic or multimetallic nanoparticles present on the catalyst is preferably up to 30 wt. %, particularly preferably up to 20 wt. %, based on the total weight of the catalyst. Too high a load leads to agglomerations of nanoparticles, which is disadvantageous.

The nanoparticles are preferably prepared by flame hydrolysis. A preferred preparation method is as follows:

At least one precursor is placed in powder form in a vessel. If bimetallic or multimetallic nanoparticles are to be prepared, different pulverulent precursors are preferably brought together and mixed thoroughly. The powders are fed to a plasma chamber or open flame and are instantaneously vaporised therein. The gaseous metal compounds so produced are discharged from the plasma and condense in a cooler region, nanoparticles having a definite size distribution being formed. The nanoparticles are stabilised in an emulsion by addition of surfactants and detergents. Water or an organic solvent is preferably used to prepare the emulsion. The emulsion, or a mixture of two or more emulsions, which contain the active component, further active components and/or promoters, is then used to impregnate a catalyst support, preferably by means of a method which is conventionally referred to in the specialist literature as “incipient wetness”. In this method, the impregnation solution containing the active components is placed in a vessel in an amount that can just be absorbed by the support to be impregnated, it thus being ensured that the active components are absorbed completely by the support. Possible further forms are to be found, for example, in patent application US20080277270-A1.

In order to remove any disruptive organic compounds from the catalyst surface and bind and stabilise the nanoparticles on the catalyst, the catalyst is subsequently calcined at elevated temperatures. Calcination is preferably carried out in an atmosphere containing oxygen, particularly preferably in air or an inert gas/oxygen mixture. The temperature is up to 800° C., preferably from 250° C. to 600° C. The calcination time is advantageously chosen to be preferably from 1 hour to 50 hours. The catalyst impregnated with the emulsion is preferably dried prior to calcination, preferably at reduced pressure and advantageously for from 1 hour to 50 hours.

Suitable as further promoters are compounds of metals having a basic action (e.g. alkali, alkaline earth and rare earth metal salts); compounds of the alkali metals, in particular Na and Cs, and alkaline earth metals are preferred; compounds of the alkaline earth metals, in particular Sr and Ba, are particularly preferred. In a preferred embodiment, the metals having a basic action are used in the form of oxides, hydroxides, chlorides, oxychlorides or nitrates. In a preferred embodiment, this type of promoter is applied to the catalyst by impregnation or CVD processes.

The support used according to the invention is preferably available commercially (e.g. from Saint Gobain Norpro).

The catalysts according to the invention for hydrogen chloride oxidation are distinguished in that they exhibit high activity while at the same time having high stability at high temperatures.

The catalytic hydrogen chloride oxidation can preferably be carried out adiabatically or isothermally or approximately isothermally, discontinuously, but preferably continuously, as a fluidised or fixed bed process, preferably as a fixed bed process, particularly preferably in tubular reactors on heterogeneous catalysts at a reactor temperature of from 180 to 500° C., preferably from 200 to 400° C., particularly preferably from 250 to 380° C., and a pressure of from 1 to 25 bar (from 1000 to 25,000 hPa), preferably from 1.2 to 20 bar, particularly preferably from 1.5 to 17 bar and especially from 2.0 to 15 bar.

Conventional reaction apparatuses in which the catalytic hydrogen chloride oxidation is carried out are fixed bed or fluidised bed reactors. The catalytic hydrogen chloride oxidation can preferably also be carried out in a plurality of stages.

In the case of the adiabatic, isothermal or approximately isothermal procedure, it is also possible to use a plurality, that is to say from 2 to 10, preferably from 2 to 6, particularly preferably from 2 to 5, especially from 2 to 3, reactors connected in series with intermediate cooling. The hydrogen chloride can be added either in totality together with the oxygen upstream of the first reactor or distributed over the various reactors. This series connection of individual reactors can also be achieved in one apparatus.

A further preferred embodiment of a device suitable for the process consists in using a structured catalyst bed in which the catalytic activity increases in the direction of flow. Such structuring of the catalyst bed can be effected by impregnating the catalyst support to differing degrees with active compound or by diluting the catalyst to differing degrees with an inert material. As inert material there can be used, for example, rings, cylinders or spheres of titanium dioxide, zirconium dioxide or mixtures thereof, aluminium oxide, steatite, ceramics, glass, graphite or stainless steel. When shaped catalyst bodies are used, as is preferred, the inert material should preferably have similar outside dimensions.

Suitable shaped catalyst bodies are shaped bodies having any desired shapes, preference being given to lozenges, extrudates, rings, cylinders, stars, cartwheels or spheres, with rings, cylinders or star-shaped extrudates being particularly preferred shapes. The dimensions (diameter in the case of spheres) of the shaped bodies are preferably in the range from 0.2 to 10 mm, particularly preferably from 0.5 to 7 mm.

As an alternative to the above-described finely divided (shaped) catalyst bodies, the support can also be a monolith of support material. A “conventional” support body having parallel channels which are not radially interconnected is preferably used. An alternative, preferred embodiment are foams, sponges or the like with three-dimensional compounds within the support body, also monoliths as well as support bodies having crossed flow channels.

The monolithic support can have a honeycomb structure or an open or closed crossed channel structure. The monolithic support has a preferred cell density of from 100 to 900 cpsi (cells per square inch), particularly preferably from 200 to 600 cpsi.

A monolith within the scope of the present invention is disclosed, for example, in “Monoliths in multiphase catalytic processes—aspects and prospects” by F. Kapteijn, J. J. Heiszwolf, T. A. Nijhuis and J. A. Moulijn, Cattech 3, 1999, p. 24.

The hydrogen chloride conversion in a single pass is in the range from 15 to 100% and can preferably be limited to from 15 to 90%, preferably from 40 to 90%, particularly preferably from 60 to 90%. All or some of the unreacted hydrogen chloride, after being separated off, can be fed back to the catalytic hydrogen chloride oxidation. The volume ratio of hydrogen chloride to oxygen at the reactor inlet is preferably from 1:1 to 20:1, particularly preferably from 2:1 to 8:1, most particularly preferably from 2:1 to 6:1.

The heat of reaction of the catalytic hydrogen chloride oxidation can advantageously be used to produce high-pressure steam. This can be used to operate a phosgenation reactor and/or distillation columns, in particular isocyanate distillation columns.

In a final step of the Deacon process, the chlorine that has formed is separated off. The separation step usually comprises a plurality of stages, namely the separation and optionally the recycling of unreacted hydrogen chloride from the product gas stream of the catalytic hydrogen chloride oxidation, drying of the resulting stream containing substantially chlorine and oxygen, and the separation of chlorine from the dried stream.

The separation of unreacted hydrogen chloride and of steam that forms can be carried out by condensing aqueous hydrochloric acid from the product gas stream of the hydrogen chloride oxidation by cooling. Hydrogen chloride can also be absorbed in dilute hydrochloric acid or water.

The Examples which follow illustrate the present invention.

### EXAMPLES

### Example 1 (Comparison Example)

### Preparation of a Catalyst not According to the Invention

100 g of TiO₂ pellets (cylindrical, diameter about 2 mm, length 2 to 10 mm, Saint-Gobain) were impregnated with a solution of ruthenium chloride n-hydrate in H₂O so that the Ru content was 3 wt. %. The moist pellets so obtained were dried overnight at 60° C. and introduced in the dry state, while flushing with nitrogen, into a solution of NaOH and 25% hydrazine hydrate solution in water, and the mixture was left to stand for 1 hour. Excess water was then evaporated off. The moist pellets were dried for 2 hours at 60° C. and then washed 4× with 300 g of water. The moist pellets so obtained were dried in a muffle furnace (air) for 20 minutes at 120° C. and then calcined for 3 hours at 350° C.

### Example 2

### Preparation of Catalysts According to the Invention Chosen by Way of Example

Stable oxides of the elements Ru (RuO₂), Sn (SnO₂), Ni (NiO), Sb (Sb₂O₅), Zr—Y (90 wt. % ZrO₂, 10 wt. % Y₂O₃), Ti (TiO₂), Bi (Bi₂O₅) were placed in the form of μm-scale powders in a vessel. The powders were fed individually (samples denoted 2a-b, 2e-i→monometallic nanoparticles) or in premixed form (samples denoted 2c-d→bimetallic nanoparticles) to a plasma chamber and were instantaneously vaporised therein (at a temperature above 20,000 K). The gaseous metal compounds so formed were discharged from the plasma and condensed in a cooler region (temperature below 500° C.), nanoparticles having a definite size distribution being formed. The nanoparticles were stabilised in an aqueous emulsion by addition of an amine-based non-ionic comb polymer (manufacturer: SDC Materials), the content of nanoparticles being established at 7.5 wt. %. In the emulsion, the desired ratio of ruthenium nanoparticles to additional nanoparticles on the catalyst was established, and the catalyst support was thereby impregnated repeatedly by means of a method conventionally referred to in the specialist literature as “incipient wetness”, until the desired total load had been applied to the catalyst support. In this method, the impregnation solution containing the active components is placed in a vessel in an amount that can just be absorbed by the support to be impregnated, it thus being ensured that the active components are absorbed completely by the support. The properties of the support, as specified by Saint-Gobain, are as follows:
mean pore diameter: 1.2 μm, BET surface area: 30 m²/g
pore volume: 0.55 cm³/g, water absorption capacity: 60 wt. %
composition: 82 wt. % alpha/transition Al₂O₃, 18 wt. % SiO₂
dimensions: d=3-4 mm, 1=6-8 mm (2a-d, 2h-i); d=3-4 mm, 1=3-4 mm (2e-g)

The moist catalyst samples were dried between the impregnation steps and finally at 110° C. for 2-5 hours and were calcined in air at 550° C. for 2 hours. The proportion of the metal content of the nanoparticles in the total weight of the catalysts is to be found in Table 1 (determined by means of XRF).

TABLE 1
Proportion of the metal content of the nanoparticles in the total weight of
the catalysts (determined by means of XRF)

| | Ru | Sn | Ni | Sb | Zr/Y | Ti | Bi |
|---|---|---|---|---|---|---|---|
| Cat | (%) | (%) | (%) | (%) | (%) | (%) | (%) |
| 2a | 1.9 | | | | | | |
| 2b | 1.6 | 4.5 | | | | | |
| 2c | 1.5 | 29 | | | | | |
| 2d | 2.1 | 11 | | | | | |
| 2e | 1.7 | | 5.0 | | | | |
| 2f | 1.9 | | | 5.1 | | | |
| 2g | 1.6 | | | | 5.2 | | |
| 2h | 2.2 | | | | | 5.9 | |
| 2i | 2.4 | | | | | | 8.9 |

### Example 3 (Comparison Example)

### Test of a Catalyst not According to the Invention (from Example 1)

1 g of the shaped catalyst bodies denoted 1 was diluted with inert Spheriglass spheres and placed in a quartz reaction tube (inside diameter 10 mm). This batch was subjected to the same measurement programme as in Example 4. The change in the STY_{Ru} and the characteristic data obtained therefrom are to be found in Table 2,

TABLE 2
Change in STY_{Ru} of a catalyst not according to the invention

| | Starting | after | | | | | |
|---|---|---|---|---|---|---|---|
| | STY_{Ru} | 19 h | after 37 h | after 103 h | after 121 h | | |
| Cat | [g/gh] | [g/gh] | [g/gh] | [g/gh] | [g/gh] | a* | b* |
| 1 | 27.0 | 23.0 | 21.7 | 20.3 | n.d. | 26.9 | 0.061 |

*for definition of parameters a and b see Example 4;
¹n.d.: not determined.

### Example 4

### Test of Catalysts According to the Invention (from Example 2)

In each case 1 g of the shaped catalyst bodies denoted 2a-i were diluted with inert Spheriglass spheres and placed in a quartz reaction tube (inside diameter 10 mm). After heating under a constant stream of nitrogen, a gas mixture (10 litres/hour) composed of 1 litre/hour hydrogen chloride, 4 litres/hour oxygen and 5 litres/hour nitrogen was passed through each of the batches at 380° C. for about 16 hours. The temperature was then lowered to 330° C. and the space-time yield was determined (starting STY). The temperature was then raised to 430° C. In order to measure the deactivation, the temperature was lowered to 330° C. in intervals (STY after x hours). The space-time yield was determined by passing the product gas stream of each of the reactors through a 20% potassium iodide solution for about 15 minutes and then titrating the resulting iodide with 0.1 N thiosulfate measuring solution (repeat determination). The specific (based on the ruthenium content) space-time yield (STY) was then determined from the amount of chloride so determined, according to the following formula (Table 3a/b):

STY_{Ru}=g(chlorine)*g⁻¹(weight of ruthenium on the catalyst used)*h⁻¹(time)

The change in STY_{Ru} was modelled using a power approach:

STY_{Ru}=at^{-b}(t in h TOS at 430° C.),

wherein a stands for the starting activity and b stands for the rate of deactivation. These two parameters have likewise been included in Table 3a/b.

TABLE 3a
Change in STY_{Ru} of catalysts according to the invention

| | Starting | after | | | | |
|---|---|---|---|---|---|---|
| | STY_{Ru} | 109 h | after 123 h | after 198 h | | |
| Cat | [g/gh] | [g/gh] | [g/gh] | [g/gh] | a | b |
| 2a | 18.4 | 17.9 | 17.4 | 16.3 | 18.5 | 0.016 |
| 2b | 33.8 | 30.0 | 29.4 | 28.8 | 33.8 | 0.029 |
| 2c | 27.3 | 20.7 | 19.3 | 18.0 | 27.5 | 0.072 |
| 2d | 25.2 | 17.6 | 17.1 | 16.7 | 25.2 | 0.079 |

TABLE 3b
Change in STY_{Ru} of catalysts according to the invention

| | Starting | after | | | | | |
|---|---|---|---|---|---|---|---|
| | STY_{Ru} | 19 h | after 37 h | after 103 h | after 121 h | | |
| Cat | [g/gh] | [g/gh] | [g/gh] | [g/gh] | [g/gh] | a | b |
| 2e | 19.4 | 21.2 | 22.4 | 21.8 | 21.2 | n.d.¹ | n.d.¹ |
| 2f | 33.7 | 26.3 | 25.3 | 22.1 | 22.6 | 33.8 | 0.086 |
| 2g | 20.0 | 18.8 | 18.8 | 17.5 | 18.1 | 20.1 | 0.024 |
| 2h | 23.6 | 22.3 | 21.4 | 20.9 | 20.5 | 23.8 | 0.029 |
| 2i | 30.7 | 29.0 | 28.5 | 26.9 | n.d.¹ | 30.9 | 0.026 |

¹n.d.: not determined

The stability (modelled deactivation parameter-b) of some catalysts according to the invention mentioned by way of example (2a, 2b, 2g, 2h, 2i) is obviously in some cases markedly higher than that of the catalyst of the prior art that is not according to the invention. The specific starting activity of some catalysts according to the invention mentioned by way of example (2b, 2f, 2) is obviously in some cases significantly higher than that of the catalyst of the prior art that is not according to the invention. Catalyst samples 2a and 2c even have a markedly higher (high-temperature) stability and a significantly higher starting activity than the catalyst according to the prior art.

### Example 5

### Size Distribution of the Nanoparticles on the Catalyst

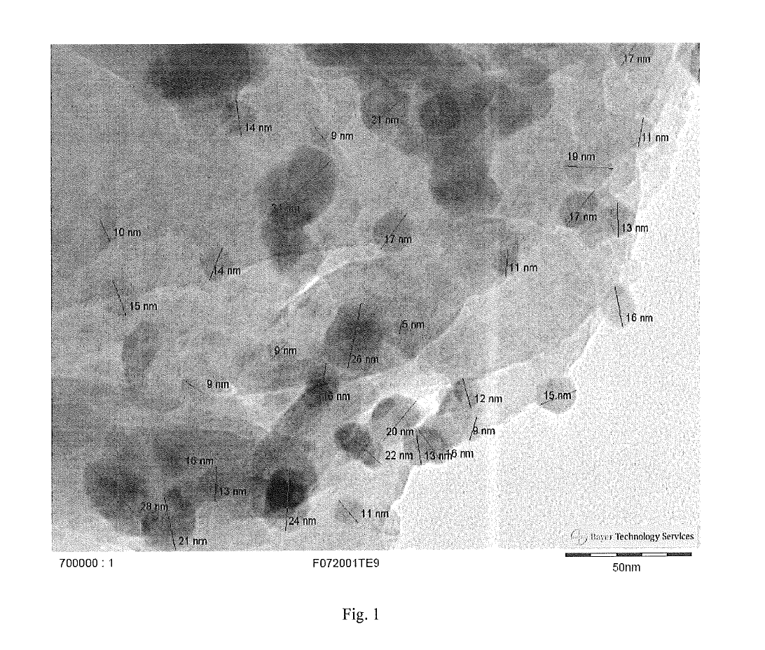

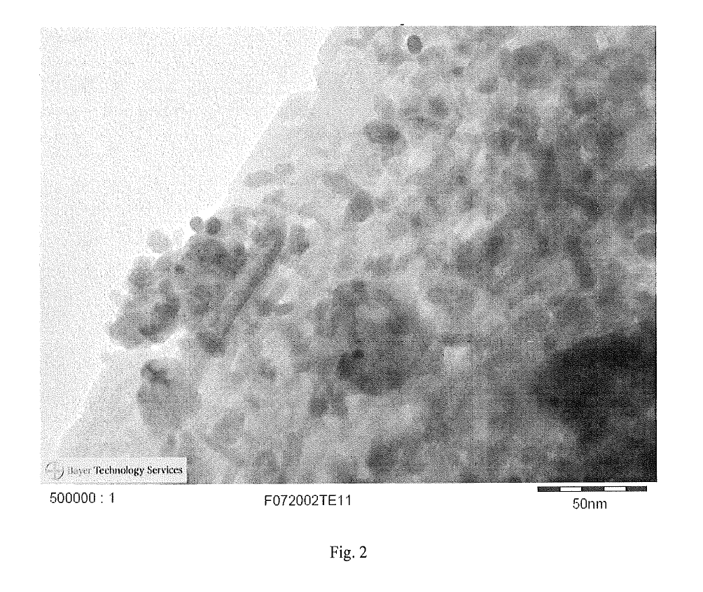

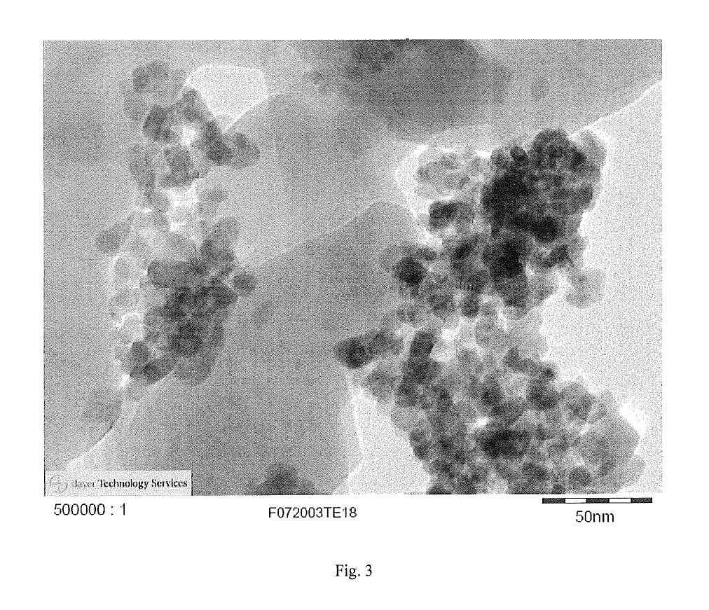

A few 10 g of the catalysts according to the invention mentioned by way of example, denoted 2a, 2b, 2c and 2d, were finely ground in a mortar and suspended in ethanol, and the resulting suspension was applied dropwise to a sample carrier for TEM measurements (Tecnai20, Megaview III). Different regions of the two samples were studied by TEM. FIG. 1 (cat. 2a), FIG. 2 (cat. 2b), FIG. 3 (cat. 2c) and

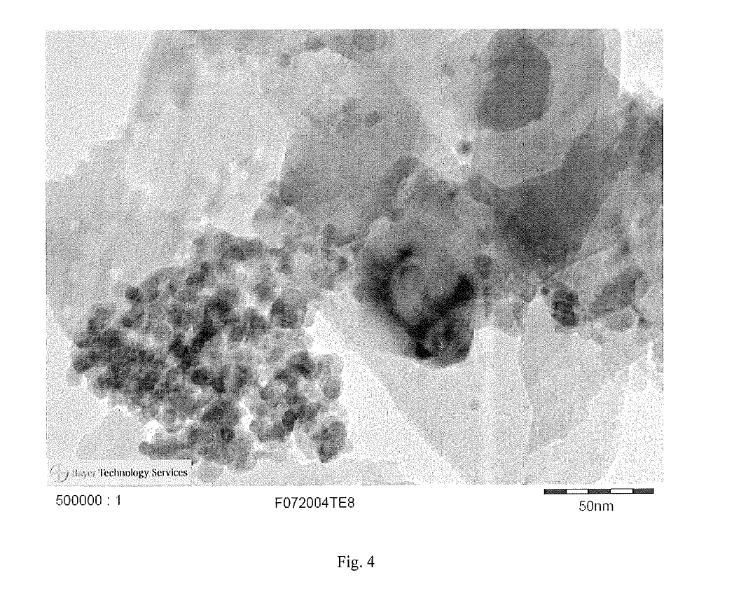

FIG. 4 (cat. 2d) show, by way of example, characteristic regions of the catalyst samples.

FIG. 1 (cat. 2a): 34 primary particles having a diameter of from 5 to 34 nm (mean 16 nm) were counted.

FIG. 2 (cat. 2b): The primary particle distribution (ruthenium dioxide and tin dioxide) is similar to that of 2a.

FIG. 3 (cat. 2c): The primary particle distribution (ruthenium dioxide and tin dioxide) is similar to that of 2a.

FIG. 4 (cat. 2d): The primary particle distribution (ruthenium dioxide and tin dioxide) is similar to that of 2a.

Unlike the catalysts according to the invention, ruthenium dioxide is obviously present on rutile-TiO₂ (see Example 1), owing to the comparable lattice spacing of the two rutile structures, in the form of a layer coating the support (“Development of an improved HCl oxidation process: structure of the RuO₂/rutile TiO₂ catalyst” by Seki, Kohei; Iwanaga, Kiyoshi; Hibi, Takuo; Issoh, Kohtaro; Mori, Yasuhiko; Abe, Tadashi in Studies in Surface Science and Catalysis (2007), 172 (Science and Technology in Catalysis 2006), 55-60). In the same publication, that catalyst is compared with supported ruthenium catalysts based on Al₂O₃ or SiO₂ which, despite presumably having a high dispersion, exhibit markedly lower activity. The high dispersion on these supports, as compared with the areal application of rutile-TiO₂, is obviously disadvantageous for the catalytic properties.

The nanostructured supported ruthenium catalysts according to the invention having defined ruthenium primary particle sizes are, however, obviously superior even to the supported ruthenium catalysts based on rutile-TiO₂.

1.-16. (canceled)

17. A catalyst material for the thermocatalytic preparation of chlorine from hydrogen chloride and oxygen-containing gas, on the basis of a supported catalyst based on ruthenium, wherein the catalyst support comprises a plurality of pores having a pore diameter greater than 50 nm and carries nanoparticles comprising ruthenium and/or ruthenium compounds as catalytically active components.

18. The catalyst material according to claim 17, wherein at least 50% of the pore volume of the catalyst material is present in pores whose diameter is greater than 50 nm.

19. The catalyst material according to claim 17, wherein at least 80% of the pore volume of the catalyst material is present in pores whose diameter is greater than 50 nm.

20. The catalyst material according to claim 17, wherein the catalyst support comprises, as support material, one or more compounds selected from the group consisting of: aluminium compounds, silicon compounds, titanium compounds, zirconium compounds and tin compounds.

21. The catalyst material according to claim 17, wherein the catalyst support comprises, as support material, one or more compounds selected from the group consisting of: aluminium compounds and silicon compounds.

22. The catalyst material according to claim 20, wherein the catalyst support comprises, as support material oxides, oxide mixtures or mixed oxides of one or more of the metals selected from the group consisting of: aluminium, silicon, titanium, zirconium and tin.

23. The catalyst material according to claim 20, wherein the catalyst support comprises, as support material oxides, oxide mixtures or mixed oxides of one or more of the metals selected from the group consisting of: mixed oxides of aluminium and silicon.

24. The catalyst material according to claim 17, wherein the ruthenium-containing nanoparticles present on the catalyst comprise, as the catalytically active component, one or more compounds selected from the group consisting of: ruthenium oxides, ruthenium mixed oxides, ruthenium oxide mixtures, ruthenium oxyhalides, ruthenium halides, metallic ruthenium.

25. The catalyst material according to claim 17, wherein at least 50% of the ruthenium-containing nanoparticles have a diameter of not more than 50 nm.

26. The catalyst material according to claim 17, wherein at least 50% of the ruthenium-containing nanoparticles have a diameter of from 5 nm to 50 nm.

27. The catalyst material according to claim 17, wherein the ruthenium-containing nanoparticles have a mean diameter of from 10 to 30 nm.

28. The catalyst material according to claim 17, wherein the catalyst has a ruthenium content of up to 20 wt. %.

29. The catalyst material according to claim 17, wherein the catalyst material further comprises nanoparticles based on one or more further metals or metal compounds as a further active component or as a promoter.

30. The catalyst material according to claim 29, wherein the one or more further metals or metal compounds and mixed compounds comprise the elements Ag, Au, Bi, Ce, Co, Cr, Cu, Ni, Sb, Sn, Ti, W, Y, Zn, Zr or Pt.

31. The catalyst material according to claim 30, wherein the further nanoparticles comprise, as metal compounds, oxides, mixed oxides, oxide mixtures, oxyhalides, halides, metals or metal alloys of at least one metal selected from the group consisting of Ag, Au, Bi, Ce, Co, Cr, Cu, Ni, Sb, Sn, Ti, W, Y, Zn, Zr and Pt.

32. The catalyst material according to claim 29, wherein the amount of the further nanoparticles present on the catalyst is up to 20 wt. % based on the total weight of the catalyst material.

33. The catalyst material according to claim 29, wherein at least 50% of the further nanoparticles additionally present on the catalyst have a diameter of not more than 50 nm.

34. A process for the preparation of the catalyst material according to claim 17, wherein the catalyst is prepared via at least the following process steps:
a) synthesizing nanoparticles comprising ruthenium and/or ruthenium compounds by flame pyrolysis,
b) stabilising the nanoparticles comprising ruthenium and/or ruthenium compounds in an emulsion,
c) (repeated) impregnating the support with the emulsion from step b), and
d) calcining the impregnated catalyst at an elevated temperature.

35. A process comprising thermocatalyticly preparing chlorine from hydrogen chloride and oxygen-containing gas, wherein the catalyst material according to claim 17 is used as a catalyst.

36. The process according to claim 35, wherein the hydrogen chloride oxidation is carried out adiabatically or isothermally or approximately isothermally as a fluidised or fixed bed process at a reactor temperature of from 180 to 500° C., and a pressure of from 1 to 25 bar (from 1000 to 25,000 hPa).
